(19) United States
(12) Patent Application Publication
(10) Pub. No.: US 2020/0382903 A1
(43) Pub. Date: Dec. 3, 2020

(54) SYSTEM AND METHOD FOR NAVIGATION AND GEOLOCATION IN GPS-DENIED ENVIRONMENTS

(71) Applicant: BAE SYSTEMS INFORMATION AND ELECTRONIC SYSTEMS INTEGRATION INC., Nashua, NH (US)

(72) Inventors: Michael N. Mercier, Nashua, NH (US); Michael R. Sweeney, Windham, NH (US); Jeffrey A. Wallace, Nashua, NH (US)

(21) Appl. No.: 16/427,966

(22) Filed: May 31, 2019

(51) Int. Cl. H04W 4/024; G01C 21/20; G06T 7/32; G06T 7/73

(52) U.S. Cl. CPC H04W 4/024; G01C 21/20; G06T 7/32; H04N 5/33; G06T 2207/10048; G06T 2207/10032; G06T 2207/30241; G06T 7/74

(57) ABSTRACT

A threat warning system and method for navigation and geolocation in Global Positioning System (GPS)-denied environments using the threat warning system is disclosed. A threat warning system carried on a platform is provided. The threat warning system includes at least one detector, at least one threat warning image sensor, at least one processor, Global Positioning System (GPS) detection logic, last known position data logic, registration logic, navigation solution logic, position correction logic, and guiding logic.

### TECHNICAL FIELD

The present disclosure relates to systems and methods for navigation and geolocation. More particularly, the present disclosure relates to systems and methods for navigation and geolocation in Global Positioning System (GPS)-denied environments. Specifically, the present disclosure relates to threat warning systems and methods for navigation and geolocation in GPS-denied environments using the threat warning systems.

### BACKGROUND

Generally, the Global Positioning System (GPS) is a global navigation satellite system that provides geolocation, time, and range information to a GPS receiver anywhere on or near the Earth where there is an unobstructed line of sight to four or more GPS satellites. Generally, modern aircraft systems typically rely on GPS for navigation and/or location and/or position information. While GPS usually provides sufficient accuracy for many aerial and ground-based navigation and geolocation applications, a typical concern associated with GPS technology is GPS interference which may make GPS unavailable and cause deleterious effects. Typical sources of GPS interference include, but are not limited to, radio frequency (RF) signals in frequency bands proximate to the GPS signals, intentional or unintentional jamming, naturally occurring meteorological conditions, and multipath effects.

### SUMMARY

Issues continue to exist with current threat warning systems and methods for navigation and geolocation in Global Positioning System (GPS)-denied environments. The present disclosure addresses these and other issues by providing a threat warning system and method that provides navigation and geolocation in GPS-denied environments using the threat warning systems locally on a platform to reduce the need for an external navigation source.

In one aspect, the present disclosure may provide a method comprising determining a last known position of a platform in response to a determination that GPS signals are not available; capturing, with at least one threat warning image sensor operably engaged with the platform, at least one scene image; registering, with at least one processor, the at least one scene image with at least one reference image to provide a registration solution; wherein the at least one reference image is based, at least in part, on the last known position of the platform; and determining a navigation solution of the platform based, at least in part, on the registration solution. The last known position may be based, at least in part, on a last-received GPS signal. Alternatively, in one example, the last known position may be provided by manually inputting the position of the platform into the at least one processor.

The method may include determining a region of interest (ROI) of the at least one scene image; wherein the at least one reference image is based, at least in part, on the ROI of the at least one scene image. The navigation solution may represent at least one of a bearing, latitude position data, longitude positon data, and altitude position data of the platform. The method may further include orthorectifying the at least one scene image and correlating the at least one scene image to the at least one reference image. The method may include determining a position correction command of the platform based, at least in part, on the navigation solution; and guiding the platform based, at least in part, on the determined position correction command. The method may further include geolocating a threat. The method may further include selecting the at least one reference image based, at least in part, on metadata of the at least one scene image. The method may include rectifying the at least one reference image with digital terrain elevation data. In one example, the platform may be an aerial platform and the sensor may be an infrared imager.

In another aspect, the present disclosure may provide a threat warning system carried on a platform comprising at least one detector; at least one threat warning image sensor for capturing a scene image; at least one processor; Global Positioning System (GPS) detection logic for determining that GPS signals are not available; last known position data logic for determining a last known position of the platform; registration logic for registering the scene image with a reference image to produce a registration solution; and navigation solution logic for determining a navigation solution of the platform based, at least in part, on the registration solution. The navigation solution may represent at least one of (i) a bearing of the platform; (ii) a latitude position of the platform; (iii) a longitude position of the platform; and (iv) an altitude position of the platform.

The threat warning system may further include position correction logic for determining a position correction command of the platform based, at least in part, on the navigation solution of the platform; and guiding logic for guiding the platform based, at least in part, on the determined position correction command. The last known position may be based, at least in part, on a last-received GPS signal. Alternatively, in one example, the last known position may be provided by manually inputting the position of the platform into the at least one processor of the threat warning system. In one example, the platform may be an aerial platform and the sensor may be an infrared imager.

In another aspect, the present disclosure may provide a threat warning system and method for navigation and geolocation in Global Positioning System (GPS)-denied environments using the threat warning system. A threat warning system carried on a platform is provided. The threat warning system includes at least one detector, at least one threat warning image sensor, at least one processor, Global Positioning System (GPS) detection logic, last known position data logic, registration logic, navigation solution logic, position correction logic, and guiding logic.

### BRIEF DESCRIPTION OF THE SEVERAL VIEWS OF THE DRAWINGS

Sample embodiments of the present disclosure are set forth in the following description, is shown in the drawings and is particularly and distinctly pointed out and set forth in the appended claims.

FIG. 1 is a diagrammatic view of a platform carrying the threat warning system of the present disclosure traveling over an environment in which a field of view from at least one threat warning sensor is directed towards a geographic landscape.

FIG. 1A is an enlarged fragmentary view of a portion of the platform carrying the threat warning system as highlighted by the dashed circle labeled SEE FIG. 1A;

FIG. 2 is a scene image captured by at least one threat warning sensor;

FIG. 3 is reference image from a reference database;

FIG. 4 is a correlated image showing one navigation solution in accordance with the present disclosure;

FIG. 5 is a correlated image showing one navigation solution in accordance with the present disclosure;

FIG. 6 is a correlated image showing one navigation solution in accordance with the present disclosure; and

FIG. 7 is a flow chart representing an exemplary method or process in accordance with the present disclosure;

Similar numbers refer to similar parts throughout the drawings.

### DETAILED DESCRIPTION

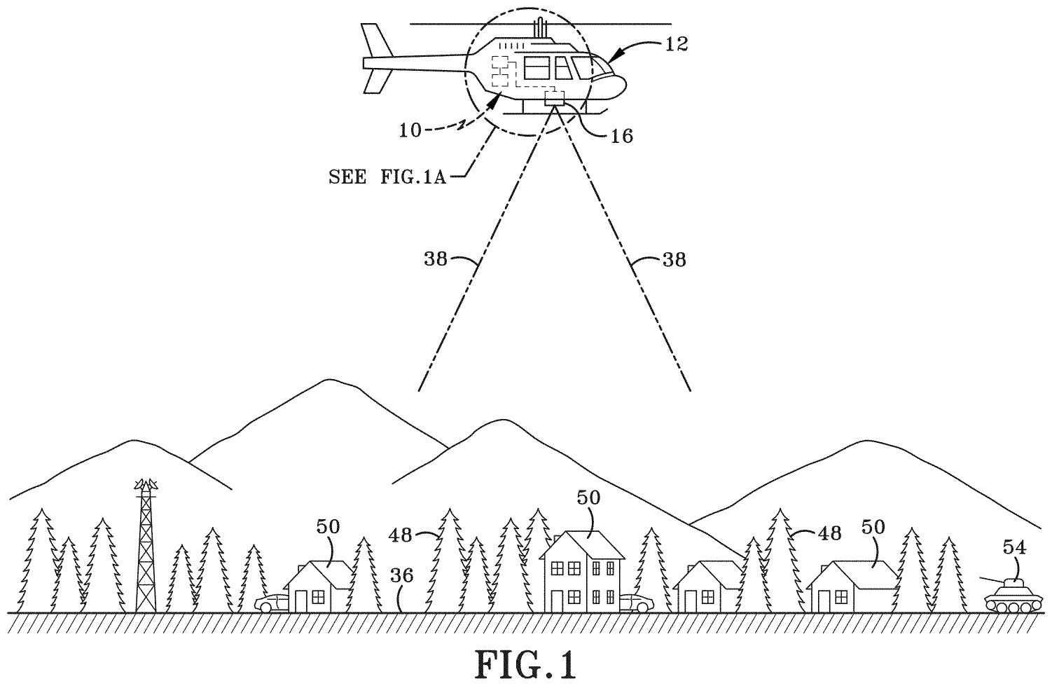

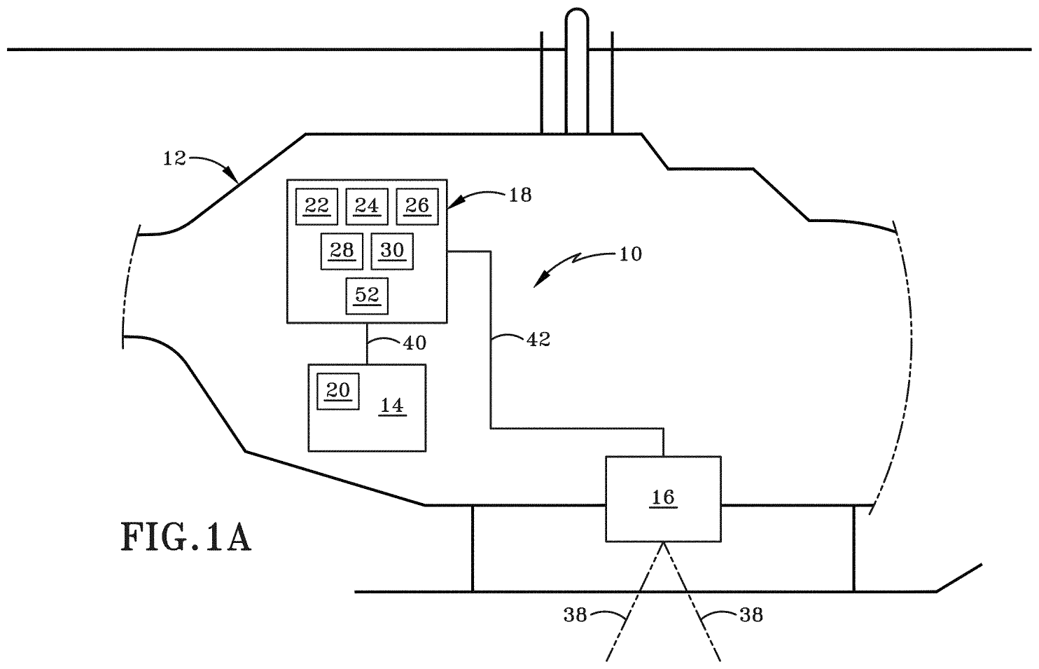

As depicted throughout FIG. 1 through FIG. 6, a threat warning system in accordance with certain aspects of the present disclosure is shown generally at 10. The threat warning system 10 is operably engaged with a platform 12 and includes at least one detector 14, at least one threat warning image sensor 16, or sensor 16, at least one processor 18, Global Positioning System (GPS) detection logic 20, last known position data logic 22, registration logic 24, navigation solution logic 26, position correction logic 28, and guiding logic 30.

In accordance with one aspect of the present disclosure, the platform 12 may be any moveable platform configured to be elevated relative to a geographic landscape 36. Some exemplary moveable platforms 12 include, but are not limited to, unmanned aerial vehicles (UAVs), manned aerial vehicles, projectiles, guided projectiles, artillery shells, missiles, rockets, or any other suitable moveable platforms.

When the platform 12 is embodied as a moveable aerial vehicle, the platform 12 may include a front end or a nose opposite a rear end or tail. Portions of the warning system 10 may be mounted to the body, the fuselage, or internal thereto between the nose and tail of the platform 12. While FIG. 1 depicts that some portions of the threat warning system 10 are mounted or carried by the platform 12 adjacent a lower side of the platform 12, it is to be understood that the positioning of some components may be varied and the figure is not intended to be limiting with respect to the location of where the components of the system 10 are provided. For example, and not meant as a limitation, the at least one detector 14 and the at least one sensor 16 are mounted on the platform 12. Furthermore, some aspects of the at least one sensor 16 may be conformal to the outer surface of the platform 12 while other aspects of the at least one sensor 16 may extend outwardly from the outer surface of the platform 12 and other aspects of the at least one sensor 16 may be internal to the platform 12.

The at least one detector 14 may be a GPS antenna receiver mounted on the side of the platform 12. The at least one detector 14 is configured to receive GPS signals from any suitable GPS signal source. Although the at least one detector 14 has been described as being a GPS antenna receiver configured to receive GPS signals, it is to be entirely understood that the at least one detector 14 may be any suitable type of receiver configured to receive any suitable satellite signals from any suitable satellite system. The at least one detector 14 is operably engaged with the at least one processor 18 and the at least one processor 18 is configured to execute software to effect processing of the received GPS signals as further described below.

The at least one sensor 16 may be an optical sensor mounted on the lower side of the platform 12. The at least one sensor 16 is configured to observe scenes remote from the platform 12, such as, for example, a geographic landscape 36 within its field of view (FOV) 38. Inasmuch as the at least one sensor 16 has a FOV 38, and in one example, the at least one sensor 16 is an image sensor or imager. Further, when the at least one sensor 16 is embodied as an imager, the imager may be any imager capable of imaging terrain, such as, for example, a visible light imager, a near-infrared imager, a mid-infrared imager, a far-infrared imager, or any other suitable imager. In one example, the imager has a frame rate of at least 100 frames per second. In another example, the imager has a frame rate of at least 500 frames per second. In yet another example, the imager has a frame rate between approximately 500 frames per second and approximately 1,000 frames per second. Although certain frame rates of the imager have been described, it is to be understood that the imager may have any suitable frame rate. The imager, or the at least one sensor 16, may be an active sensor or a passive sensor. However, certain aspects of the present disclosure are operative with the at least one sensor 16 being a passive sensor 16. As will be discussed in greater detail below, the term “passive” with respect to the at least one sensor 16 or the imager refers to the fact that the at least one sensor 16 or the imager receives data observed through its FOV 38 of the scene that is being observed, but does not transmit signals.

Furthermore, when the at least one sensor 16 is embodied as an imager, the imager will have some components that are common to image sensors such as lens, domes, focal plane arrays, and may additionally include processors and associated processing hardware. Towards that end, a reader of the present disclosure will understand that the at least one sensor 16 may include standard imaging components adapted to sense, capture, and detect imagery within its FOV 38. The imagery may be in a spectrum that is not viewable to the human eye, such as, for example, near-infrared imagery, mid-infrared imagery, and far-infrared imagery.

While the FOV 38 in FIG. 1 is directed vertically downward towards the geographic landscape 36, it is further possible for a system in accordance with the present disclosure to have a sensor 16 that projects its FOV 38 outwardly and forwardly from the nose of the platform 12 or outwardly and rearwardly from the tail of the platform 12, or in any other suitable direction. However, as will be described in greater detail below, certain implementations and embodiments of the present disclosure are purposely aimed downward so as to capture a scene image from the geographic landscape 36 to be used to provide navigation and/or position and/or location and/or geolocation information to the platform 12.

Generally, the detector 14 has an input and an output. An input to the detector 14 may be considered the GPS signals from a GPS signal source that is processed through the detecting components within the detector 14. An output of the detector may be GPS signals containing GPS information received by the detector 14 that is output to another hardware component or processing component.

Generally, the sensor 16 has an input and an output. An input to the sensor 16 may be considered the scene image observed by the FOV 38 that is processed through the imagery or sensing components within the sensor 16. An output of the sensor may be an image captured by the sensor 16 that is output to another hardware component or processing component.

FIG. 1A depicts the at least one processor 18 is in operative communication with the at least one detector 14 and the at least one sensor 16. More particularly, the at least one processor 18 is electrically connected with the output of the detector 14 and the output of the sensor 16. In one example, the at least one processor 18 is directly wired to the output of the detector 14 and the output of the sensor 16. However, it is equally possible for the at least one processor 18 to be wirelessly connected to the detector 14 and the sensor 16. Stated otherwise, a link 40 electrically connects the detector 14 to the at least one processor 18 and may be any wireless or wired connection to effectuate the transfer of digital information or data from the detector 14 to the at least one processor 18. The at least one processor 18 is configured to or is operative to generate a signal in response to the data received over the link 40 from the detector 14. In some implementations, the data that is sent over the link 40 are the GPS signals received by the detector 14 from the GPS signal source. Likewise, a link 42 electrically connects the sensor 16 to the at least one processor 18 and may be any wireless or wired connection to effectuate the transfer of digital information or data from the sensor 16 to the at least one processor 18. The at least one processor 18 is configured to or is operative to generate a signal in response to the data received over the link 42 from the sensor 16. In some implementations, the data that is sent over the link 42 are scene images captured by the sensor 16 that is observing the geographic landscape 36 below through its FOV 38. As will be described in greater detail below, the detector 14 may include GPS detection logic 20, and the at least one processor 18 may include various logics, such as, for example, last known position data logic 22, registration logic 24, navigation solution logic 26, position correction logic 28, and guiding logic 30 which performs functions described in greater detail below.

With continued reference to FIG. 1, and having thus described the general structure of system 10, reference is now made to features of the geographic landscape 36. For example, and not meant as a limitation, the geographic landscape 36 may include natural features 48, such as trees, vegetation, or mountains, or manmade features 50, such as buildings, roads, or bridges, etc., which are viewable from the platform 12 through the FOV 38 of the sensor 16.

Having thus described the exemplary structural configuration of some aspects of the system 10, reference will now be made to the operation in which the system 10 uses the detector 14, the sensor 16, and the various logics, such as, for example, GPS detection logic 20, last known position data logic 22, registration logic 24, navigation solution logic 26, position correction logic 28, and guiding logic 30.

The detector 14 detects GPS signals from any suitable GPS signal source. The output of the detector 14 are GPS signals containing GPS data, which may also be referred to as position information, received by the detector 14 that are processed by another hardware component or processing component. Specifically, the GPS detection logic 20 may include at least one non-transitory computer readable storage medium having instructions encoded thereon that, when executed by the at least one processor 18, implements operations to determine whether GPS signals are being received by the at least one detector 14 at a suitable level to determine a position of the at least one detector 14, and, in turn, a position of the platform 12. The GPS data includes altitude position data, latitude position data, and longitude position data (e.g., altitude, latitude, and longitude coordinates; however, the GPS data may include any suitable data which allows a position to be determined. If the GPS detection logic 20 determines that the GPS signals are being received at a suitable level to determine a position of the at least one detector 14, and, in turn, a position of the platform 12, the last known position data logic 22 may include at least one non-transitory computer readable storage medium having instructions encoded thereon that, when executed by the at least one processor 18, implements operations to determine a last known position of the platform 12. The last known position of the platform 12 may be iteratively updated each time the GPS signals are processed by the detector 14. If the GPS detection logic 20 determines that the GPS signals are not being received, or are not being received at a suitable level to determine a position of the at least one detector 14, and, in turn, a position of the platform 12, the last known position of the platform 12 may be provided in an alternate manner, such as, for example, manually inputting the last known position of the platform 12 into the at least one processor 18. Further, if the platform 12 does not have access to GPS signals, the at least one processor 18 utilizes the threat warning system 10 of the present disclosure for, inter alia, navigation and/or location and/or position and/or geolocation applications as more fully described below.

For example, and not meant as a limitation, if the platform 12 is an aerial vehicle flying in an area where GPS signals are available at a suitable level to determine a position of the at least one detector 14, and, in turn, a position of the platform 12, the aerial vehicle may utilize the GPS signals for navigation and/or location and/or position and/or geolocation applications. However, if the GPS signals are jammed, blocked, or otherwise degraded to an unsuitable level, the aerial vehicle cannot utilize the GPS signals for navigation and/or location and/or position and/or geolocation purposes and a different system, such as the system 10 of the present disclosure, may be utilized as further described below.

The system 10 uses the sensor 16 to capture a scene image from a scene remotely from the platform 12 and the at least one processor 18 generates a signal in response to the sensor 16 capturing the scene image. Metadata may be provided for each captured scene image. For example, and not meant as a limitation, the metadata may include a frame number of the scene image within a flight data set, a latitude position of the platform 12 in radians, a longitude position of the platform 12 in radians, an altitude position of the platform 12 in meters, a velocity of the platform 12 in meters per second, and a rotation of the platform 12 in degrees. Metadata associated with the at least one sensor 16 may also be provided, such, as, for example, mounting information related to the at least one sensor 16. Although examples of metadata have been provided, it is to be understood that the metadata may include any suitable data and/or information.

The registration logic 24 may include at least one non-transitory computer readable storage medium having instructions encoded thereon that, when executed by the at least one processor 18, implements operations to register the scene image captured by the sensor 16 with a reference image to provide a registration solution.

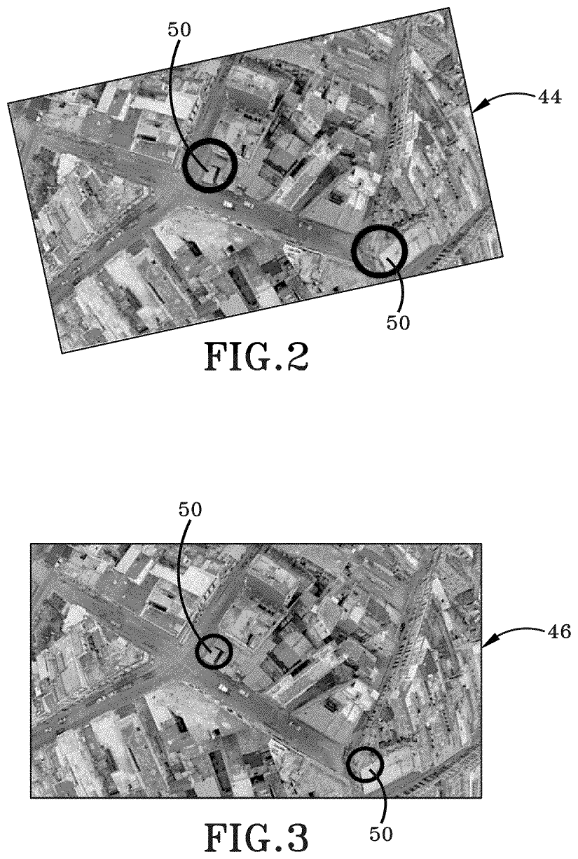

FIG. 2 depicts an exemplary scene image 44 and FIG. 3 depicts an exemplary reference image 46. The storage medium of the registration logic 24 may include a database of known reference images to be used as ground-truth data to determine a location of the platform 12. The manner in which the database of the registration logic 24 populates the reference database may be prepopulated prior to flight of the platform 12; however, it is entirely possible for the database to be built in situ while the platform 12 is in motion. In one example, the reference imagery database may include geotagged reference imagery, which contain geographical identification metadata typically including latitude coordinates, longitude coordinates, altitude coordinates, or any other suitable geospatial metadata; however, the reference imagery database may include any suitable reference imagery. Further, the reference images may be rectified with a geo-referenced elevation map, such as, for example, a map that uses Digital Terrain Elevation Data (DTED), which is a standard of digital datasets which contains a matrix of terrain elevation values. The reference images may be selected based, at least in part, on sensor metadata associated with the at least one scene image. Sensor metadata provides information regarding, among other things, sensor location and sensor orientation. The metadata may be used to, among other things, provide an estimate of platform 12 location and sensor 16 pointing directions of the platform 12.

The at least one processor 18 may register the scene image captured from the sensor 16 against a reference image selected from a known database to provide a registration solution. The registration solution may include information such as, but not limited to, navigation and/or location and/or position and/or geolocation information.

In one example, registering the scene image includes orthorectifying the scene image which typically converts the scene image into a “birds-eye” point of view and removes axis-skew from the scene image allowing a more accurate image correlation step to be performed. In this process, the inputs are the scene image, pixel-angle mapping, and, if a previous navigation solution has been produced, the previous navigation solution. The output of this process is the orthorectified image.

The orthorectification process may be performed as follows: four corners of each pixel (r,) of the scene image are projected as points onto the ground (x,y) using the pixel-to-angle mapping provided by the sensor manufacturer, the known sensor-to-platform mounting (specified by rotation matrix M), and the altitude and attitude (specified by rotation matrix A) of the platform. Note that only the roll and pitch of the platform are used in matrix A. It is assumed that a down vector is known, but not the bearing (yaw) of the platform. The process converts a coordinate in pixel space (i.e. (r,)) to a coordinate in angle space (i,j,k) relative to the projection of the sensor boresight into the plane parallel to the ground. This can be modeled by the following equation:

$$[ \begin{matrix}i \\ j \\ k\end{matrix} ] = A * M * Pixel 2 SensorCoordinate ( r , c ) \qquad Equation ( 1 )$$

The process computes a ground coordinate (x,) using the platform's 12 current altitude. The y-axis of the ground coordinate system is defined by the projection of the sensor boresight onto the ground and the x-axis is defined as the orthogonal axis. In this coordinate system, the location of the platform 12 projected onto the ground plane is defined as the origin. The ground coordinate (in meters) can be calculated using the following equation:

$$( x , y ) = \frac{altitude}{k} * ( j , i ) . \qquad Equation ( 2 )$$

Note that a flat-earth model is assumed in this calculation. It is to be understood that data sets such as DTED may be used to compute a more accurate projection. The ground coordinates are translated back into pixel space using a specified ground-sampling distance (GSD) in meters per pixel. This GSD may be chosen to match the GSD of the reference imagery as closely as possible. The corners of each pixel define an area bounded by two arcs. The pixels within this arc are colored using the pixel value of the original image at pixel (r,). In this process, multiple pixels (r,) can map to the same pixel (x,y). In this case, the value of the pixel (x,) is the average of all pixels that map to it. An alternative method may use the weighted average of the pixels, where each source pixel is weighted by the area of the rectified pixel that it covers.

After the scene image has been orthorectified, the orthorectified image is compared against the “ground-truth” reference image. The image correlation process is scale and rotation invariant which accounts for variations in altitude and in heading of the platform 12 from the stored reference image. Exemplary correlating processes include Binary Robust Invariant Scalable Keypoints (BRISK) and Speeded-up Robust Features (SURF); however, any other suitable process may be utilized.

In this example, the BRISK process is used to extract multiscale corner features from the scene image and the reference imagery, which are then mapped between the two images to yield the mapping parameters. The angle and scaling factor needed to rectify the scene image with the reference image are recovered through checking how a unit vector parallel to the x-axis of the captured scene image is rotated and stretched. The SURF process is used to extract blob features from the scene image and the reference imagery, and is used in tandem with the features extracted from the BRISK process if the BRISK process failed to yield enough features to perform the translation. In one example, correlating a baseline visual reference image with a translated reference image.

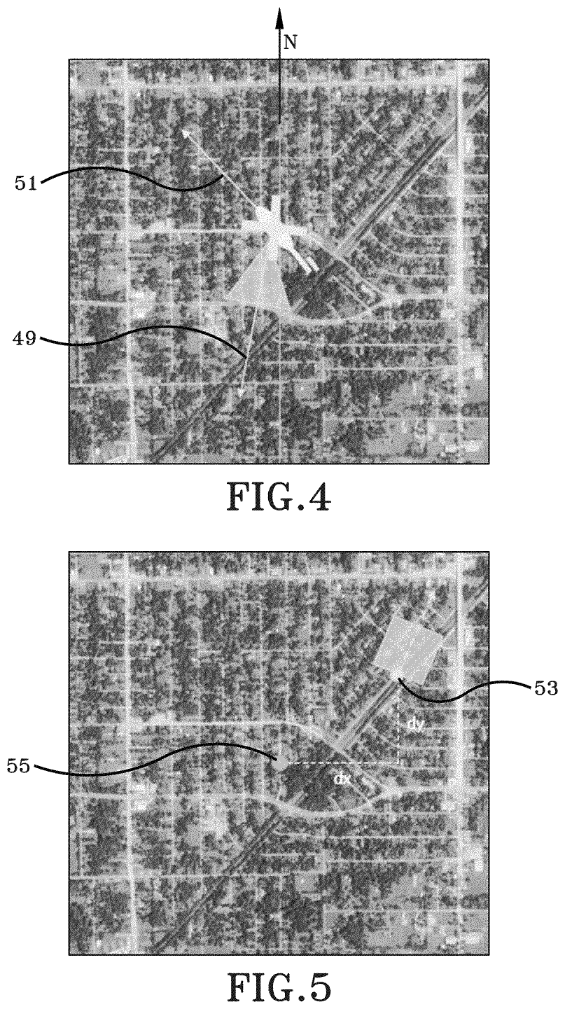

After the scene image has been correlated with the reference image and the rotation and scaling factors have been extracted, the navigation solution logic 26 may compute a navigation solution of the platform 12 from the image correlation results. Stated otherwise, a vision-based position measurement may be generated by the navigation solution logic 26. The navigation solution logic 26 may include recovering a bearing of the platform 12, which is shown in FIG. 4. The bearing of the platform 12 may be calculated as follows:

Bearing=θ+0 Equation (3)

where θ=rotation from North, which is shown as N in FIG. 4) to sensor boresight, denoted as 49 in FIG. 4, which is derived from the image correlation results, and where ϕ=rotation from sensor boresight to nose, denoted as 51 in FIG. 4, of platform 12, which is given by the known sensor mounting.

The navigation solution logic 26 may include recovering a latitude position and a longitude position of the platform 12, which is shown in FIG. 5. The latitude position and longitude position of the platform 12 may be calculated as follows:

(Δx,Δy)=matched pixel−center pixel Equation (4)

where Δx is denoted as dx in FIG. 5, Δy is denoted as dy in FIG. 5, matched pixel is denoted as 53 in FIG. 5, and center pixel is denoted as 55 in FIG. 5;
and

Platform latitude=center latitude+Δy×meters/pixel×latitude in degrees/meters Equation (5);

and

Platform longitude=center longitude−Δx×meters/pixel×longitude in degrees/meters Equation (6).

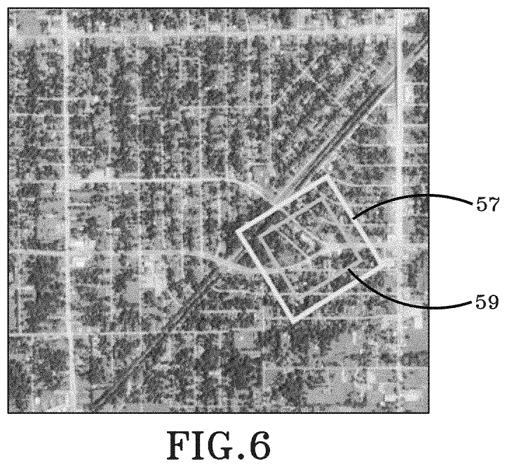

The navigation solution logic 26 may include recovering an altitude position of the platform 12, which is shown in FIG. 6. The altitude of the platform 12 may be calculated as follows where the measured scaling factor is directly proportional to the error in altitude:

measured scale=length(matched)/length(reference) Equation (7)

where matched is denoted as 57 is FIG. 6 and reference is denoted as 59 in FIG. 6;
and

expected scale=GSD of scene image/GSD of reference image Equation (8);

and

altitude_{f}=altitudeₘ×measured scale/expected scale Equation (9).

In another example, registration of the scene image with the reference image may be accomplished by aligning features of the scene image with features of the reference image. The features may include, but are not limited to, natural features 48, such as trees, vegetation, or mountains, and the like or manmade features 50, such as buildings, roads, or bridges, and the like. Known map distances, such as, for example, map distances in meters or degrees, of the features in the scene image and the reference image may be aligned. Alternatively, registering the scene image with the reference image to provide a registration solution may be accomplished by using sensor lens distortion parameters (e.g., pixel to angle) and triangulation to calculate an altitude position, a latitude position, and a longitude position of the platform 12. Although certain registration processes have been identified, the registration logic 24 may utilize any suitable registration process to register the at least one scene image with the at least one reference image.

The position correction logic 28 may include at least one non-transitory computer readable storage medium having instructions encoded thereon that, when executed by the at least one processor 18, implements operations to a determine position correction command of the platform 12 based, at least in part, on the navigation solution of the platform 12. The position correction command may include a bearing, a latitude position, a longitude position, and an altitude position of the platform 12; however, the position correction command may include any suitable position data.

The guiding logic 30 may include at least one non-transitory computer readable storage medium having instructions encoded thereon that, when executed by the at least one processor 18, implements operations to guide the platform 12 based, at least in part, on the determined position correction command. The guiding logic 30 may include bearing, a latitude position, a longitude position, and an altitude position of the platform 12; however, the guiding logic 30 may include any suitable position data.

Determining that GPS signals are not available occurs after the determination of the last known position of the platform 12. Stated otherwise, the determination of the last known position of the platform 12 may be provided by GPS signals, and, after the determination of the last known position of the platform 12, GPS signals may be jammed, blocked, or otherwise degraded and the platform 12 would then rely on the system 10 for navigation and/or location and/or positon and/or geolocation applications. The detector 14 may not receive any GPS signals, for example, if the platform 12 enters a GPS-denied environment, and, in this case, the last known position of the platform 12 may be entered manually into the at least one processor 18 or otherwise provided to the platform 12 in any suitable manner.

The system 10 further comprises geolocating logic 52. The geolocating logic 52 may include at least one non-transitory computer readable storage medium having instructions encoded thereon that, when executed by the at least one processor 18, implements operations to geolocate a threat 54 (FIG. 1). The geolocating logic 52 may include bearing position data, altitude position data, latitude position data, and longitude position data; however, the geolocating logic 52 may include any suitable position data. For example, and not meant as a limitation, the sensor 16 may capture a scene image containing a hostile threat. After the scene image is registered to the reference image as described above, the geolocating logic 52 provides position data associated with the hostile threat which can then be used by the platform 12 to target or avoid the threat 54.

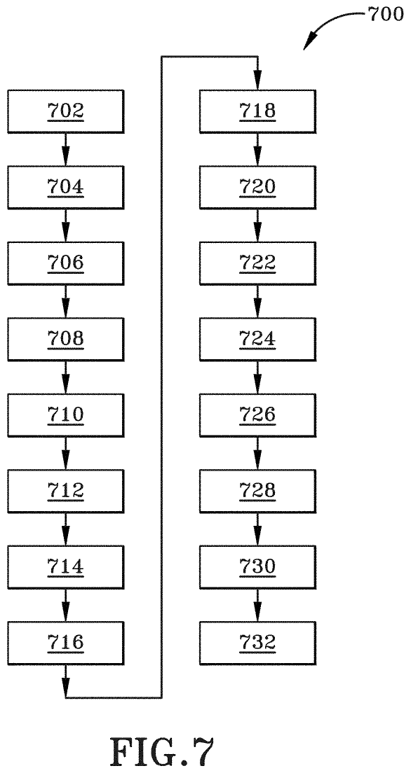

FIG. 7 depicts a method in accordance with one aspect of the present disclosure generally at 700. The method 700 may include determining a last known position of a platform in response to a determination that GPS signals are not available, which is shown generally at 702. The GPS detection logic 20 may determine whether GPS signals are being received by the at least one detector 14 at a suitable level to determine a position of the at least one detector 14, and, in turn, a position of the platform 12, which is shown generally at 704. In another example, the detector 14 may not receive any GPS signals, for example, if the platform 12 enters a GPS-denied environment, and, in this case, the last known position of the platform 12 may be entered manually into the at least one processor 18 or otherwise provided to the platform 12 in any suitable manner, which is shown generally at 706. If GPS signals are jammed, blocked, or otherwise degraded to an unsuitable level, then the system 10 provides navigation and/or location and/or position and/or geolocation applications, which is shown generally at 708. Specifically, the at least one processor 18 utilizes the GPS signals for navigation and/or location and/or position and/or geolocation applications, which is shown generally at 710. In one example, the last known position may be based, at least in part, on a last-received GPS signal. In other words, the system 10 utilizes a GPS signal to determine the last known position of the platform 12 before the GPS signals become jammed, blocked, or otherwise degraded to an unsuitable level. The method 700 may include capturing, with the at least one threat warning image sensor 16 operably engaged with the platform 12, at least one scene image, which is shown generally at 712. The method 700 may include registering, with at least one processor 18, the at least one scene image with at least one reference image to provide a registration solution; wherein the at least one reference image is based, at least in part, on the last known position of the platform 12, which is shown generally at 714. The method 700 may include determining a navigation solution of the platform 12 based, at least in part, on the registration solution, which is shown generally at 716. The navigation solution may represent at least one of a bearing, a latitude position, a longitude position, and an altitude position of the platform 12. The method 700 may further include determining a region of interest (ROI) of the at least one scene image; wherein the at least one reference image is based, at least in part, on the ROI of the at least one scene image, which is shown generally at 718. The method 700 may further include orthorectifying the at least one scene image, which is shown generally at 720. The method 700 may further include correlating the at least one scene image to the at least one reference image, which is shown generally at 722. The method 700 may further include determining a position correction command of the platform 12 based, at least in part, on the navigation solution, which is shown generally at 724. The method 700 may further include guiding the platform based, at least in part, on the determined position correction command, which is shown generally at 726. The method 700 may further include geolocating a threat, which is shown generally at 728. The method 700 may further include selecting the at least one reference image based, at least in part, on metadata of the at least one scene image, which is shown generally at 730. The method 700 may further include rectifying the at least one reference image with digital terrain elevation data, which is shown generally at 732.

According to another aspect, the threat warning system 10 may allow evaluation and utilization of legacy systems in the implementation of the processes discussed herein. Specifically, the threat warning system 10 assets may be legacy assets which may be retrofitted with software or other instructions to accomplish the features of the present disclosure without significantly increasing size, weight, power, or cost to existing legacy threat warning systems. Processes described herein may be uploaded to existing legacy assets, or may be added thereto through the use of an additional memory module, including an additional non-transitory storage medium, or through the use of temporary memory devices, such as flash memory or the like. Accordingly, the threat warning system 10 may allow these existing legacy assets to be optimized and used without adjustments thereto.

It is to be understood that the various logics, such as the GPS detection logic 20, the last known position data logic 22, the registration logic 24, the navigation solution logic 26, the position correction logic 28, and the guiding logic 30 may utilize any suitable number of non-transitory computer readable storage mediums. For example, and not meant as a limitation, the various logics can be stored on one non-transitory computer readable storage medium or multiple computer readable storage mediums.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The indefinite articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Additionally, the method of performing the present disclosure may occur in a sequence different than those described herein. Accordingly, no sequence of the method should be read as a limitation unless explicitly stated. It is recognizable that performing some of the steps of the method in an different order could achieve a similar result.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

1. A method comprising:
determining a last known position of a platform in response to a determination that GPS signals are not available;
capturing, with at least one threat warning image sensor operably engaged with the platform, at least one scene image;
registering, with at least one processor, the at least one scene image with at least one reference image to provide a registration solution; wherein the at least one reference image is based, at least in part, on the last known position of the platform; and
determining a navigation solution of the platform based, at least in part, on the registration solution.

2. The method of claim 1, further comprising:
determining a region of interest (ROI) of the at least one scene image; wherein the at least one reference image is based, at least in part, on the ROI of the at least one scene image.

3. The method of claim 1, wherein the navigation solution represents a bearing of the platform.

4. The method of claim 1, wherein the navigation solution represents latitude position data of the platform.

5. The method of claim 1, wherein the navigation solution represents longitude position data of the platform.

6. The method of claim 1, wherein the navigation solution represents altitude position data of the platform.

7. The method of claim 1, further comprising:
orthorectifying the at least one scene image.

8. The method of claim 1, further comprising:
correlating the at least one scene image to the at least one reference image.

9. The method of claim 1, further comprising:
determining a position correction command of the platform based, at least in part, on the navigation solution; and
guiding the platform based, at least in part, on the determined position correction command.

10. The method of claim 1, wherein the last known position is based, at least in part, on a last-received GPS signal.

11. The method of claim 1, further comprising:
geolocating a threat.

12. The method of claim 1, wherein the platform is an aerial platform.

13. The method of claim 1, wherein the at least one threat warning image sensor is an infrared imager.

14. The method of claim 1, further comprising:
selecting the at least one reference image based, at least in part, on metadata of the at least one scene image.

15. The method of claim 1, further comprising:
rectifying the at least one reference image with digital terrain elevation data.

16. A threat warning system carried on a platform comprising:
at least one detector;
at least one threat warning image sensor for capturing a scene image;
at least one processor;
Global Positioning System (GPS) detection logic for determining that GPS signals are not available;
last known position data logic for determining a last known position of the platform;
registration logic for registering the scene image with a reference image to produce a registration solution; and
navigation solution logic for determining a navigation solution of the platform based, at least in part, on the registration solution.

17. The threat warning system of claim 16, wherein the navigation solution represents at least one of (i) a bearing of the platform; (ii) a latitude position of the platform; (iii) a longitude position of the platform; and (iv) an altitude position of the platform.

18. The threat warning system of claim 17, further comprising:
position correction logic for determining a position correction command of the platform based, at least in part, on the navigation solution of the platform; and
guiding logic for guiding the platform based, at least in part, on the determined position correction command.

19. The threat warning system of claim 16, wherein the last known position is based, at least in part, on a last-received GPS signal.

20. The threat warning system of claim 16, wherein the at least one threat warning image sensor is an infrared imager.
